(19) United States
(12) Patent Application Publication
(10) Pub. No.: US 2008/0030138 A1
(43) Pub. Date: Feb. 7, 2008

(54) Lamp Cover

(76) Inventor: Allen P. Turner, Harrison Township, MI (US)

Correspondence Address: GREGORY T. ZALECKI, 12900 HALL ROAD, SUITE 400, STERLING HEIGHTS, MI, 48313, US

(21) Appl. No.: 11/461,799

(22) Filed: Aug. 2, 2006

(51) Int. Cl. H01J 1/62; H01J 61/30; H01J 63/04

(52) U.S. Cl. 313/634; 313/489

(57) ABSTRACT

A high-intensity discharge lamp may be converted to a yellow bug lamp by covering it with a lamp cover. This will minimize or eliminate the attraction of insects to the lamp. The lamp cover is comprised of a bag shaped jacket having an open end. The jacket is constructed from a flexible light transmitting material capable of withstanding a temperature of at least 650° C. without degradation, such as fiberglass. The jacket is shaped to cover the bulb of a lamp such that the jacket may be manually installed upon and removed from the bulb. The jacket is colored yellow. The color may be supplied by a dye or a high-temperature paint, capable of withstanding temperatures exceeding 650° C. The lamp cover may be secured to the lamp with a clamp.

### BACKGROUND

Many lighting applications use high-intensity discharge lamps. High-intensity discharge lamps are commonly used to light parking lots, sports venues and the interiors of commercial buildings. They are also used to illuminate signs. The reason for the popularity of high-intensity discharge lamps is that they produce bright white light and they produce the light efficiently.

Three general categories of high-intensity discharge lamps exist. The three categories are high-pressure sodium lamps, mercury vapor lamps and metal halide lamps. These lamps produce light within a centralized arc tube. The arc tube is surrounded by a bulb. The arc tubes reach very high temperatures during operation. The arc tube temperatures can range between 900° C. and 1100° C. Metal halide lamps are often preferred because they produce a brighter and whiter light. Metal halide lamps are also associated with the most extreme arc tube and bulb temperatures compared to high-pressure sodium lamps and mercury vapor lamps.

The bright white light produced by high-intensity discharge lamps can also cause problems. One major problem is that insects are attracted to the bright white light. This can be annoying to people in the vicinity. It can also result in insect bites. For example, in the Lake Erie basin mayflies are attracted to the bright white light in substantial numbers. It is not unusual for walking and driving surfaces to be covered by mayflies. When they are crushed some susceptible people even suffer asthma type symptoms from breathing air infiltrated with crushed insects.

It is often not practical to simply shut off lights to avoid attracting insects. Business owners do not want to turn off lights in their parking lots to reduce the number of insects in the area. Lights are needed for the convenience and safety of business customers, even during insect season. While spraying insect repellent or poison in an insect infested area may provide relief from the insects, this solution also produces undesirable side effects. The repellent or poison is also likely to come into contact with human beings. This can cause harmful or unknown consequences because many insect poison and insect repellent chemicals have not been fully tested to prove their safety. Guests in resort areas do not want to be annoyed by insects. However, they do not want to be exposed to undesirable chemicals. Many remember when the insect poison DDT was first used. It was initially thought to be a safe chemical only to be determined later to be a substantial environmental and health hazard.

A nonchemical solution to the problems caused by insects being attracted to white light exists. The attraction of insects to light can be reduced or eliminated by changing the color of the light from white to yellow. Unfortunately, high-intensity discharge lamps are costly. It is undesirable to remove white high-intensity discharge lamps and replace them with yellow high-intensity discharge lamps during insect seasons because of the associated cost. A second set of costly lamps becomes necessary only to reduce insect infestation. Additionally, significant labor may be involved in changing the lamps.

What is needed is a lamp cover with the following features. It would facilitate converting a white high-intensity discharge lamp to a yellow high-intensity discharge lamp. It could also facilitate conversion to a different color for aesthetic purposes. It would be easy to install and easy to remove. It would have good heat dissipation properties. Neither the material used to fabricate the cover or any agent used to color the cover would degrade or combust at typical lamp operating temperatures. A review of the specifications relating to metal halide lamps shows a range of bulb operating temperatures ranging from 400° C. to 650° C. Metal halide lamps tend to be the hottest lamps within the high-intensity discharge lamp family.

### SUMMARY

These needs are satisfied by the lamp cover described herein. The lamp cover is comprised of a bag shaped jacket. The jacket has an open end. This is where the bulb of a lamp is inserted into the jacket during use. The jacket is constructed from a flexible light transmitting material. The material is capable of withstanding a temperature of at least 650° C. without degradation. The jacket is shaped to cover the bulb of a lamp such that the jacket may be manually installed upon and removed from the bulb. The jacket has a nonwhite color.

Preferably, the flexible light transmitting material is fiberglass. The preferred type of fiberglass is woven fiberglass cloth. Other types of fiberglass such as fiberglass woven roving, fiberglass roving, fiberglass mat and of fiberglass fabric may also be used. Polytetrafluoroethylene, commonly sold under the trade name TEFLON, may also be used. Both of these materials are capable of withstanding a temperature of at least 650° C. without degradation.

For aesthetic uses the nonwhite color of the jacket may be any color. The colored jacket will filter the white light produced by the lamp and only transmit light with a nonwhite color. In order to optimize the lamp cover to facilitate converting a white light lamp to a lamp with reduced or eliminated insect attraction properties, the jacket should be colored yellow. This will cause the lamp to emit a yellow light when the lamp cover covers the lamp. The emitted yellow light will be much less attractive to insects than the white light produced by the lamp covered by the lamp cover.

The agent used to color the jacket material must also be capable of withstanding temperatures exceeding 650° C. without degradation. The jacket can be colored by covering the surface of the jacket with a layer of high-temperature paint capable of withstanding temperatures exceeding 650° C. without degradation. Silica and ceramic based coatings having such properties are currently being marketed. One such product is being sold by PJ1 under the trade names “VHT” and “FLAMEPROOF.” This product is being sold as an engine header paint intended for use upon engine headers having peak temperatures of 1300-2000° F. (704-1093° C.).

Another way to color the flexible light transmitting material forming the jacket is to dye the material with a nonflammable dye. Dyed fiberglass is capable of withstanding temperatures of at least 650° C. without degradation. Dyes are available in a wide variety of colors. Therefore, when the jacket material is dyed, the color of the light to be emitted by a covered lamp can be incrementally shaded to any desired color.

### DRAWINGS

These and other features, aspects, and advantages of the present invention will become better understood with regard to the following description, appended claims, and accompanying drawings where:

FIG. 1 is a perspective view of a high-intensity discharge lamp covered by a lamp cover.

FIG. 2 is a perspective view of the high-intensity discharge lamp of FIG. 1 with the lamp cover removed, showing insects attracted to the lamp.

FIG. 3 is an exploded elevation view of the high-intensity discharge lamp and lamp cover of FIG. 1.

FIG. 4 is an elevation view showing the bulb of the lamp of FIG. 3 installed into the lamp cover of FIG. 3, wherein the lamp cover is secured to the lamp with a clamp.

FIG. 5 is a sectional view of the lamp cover and lamp of FIG. 4.

FIG. 6 is a sectional view of the lamp cover of FIG. 5 showing the jacket of the lamp cover covered by a layer of high-temperature paint.

FIG. 7 is an exploded view of the lamp cover jacket and the layer of high-temperature paint of FIG. 6.

### DESCRIPTION

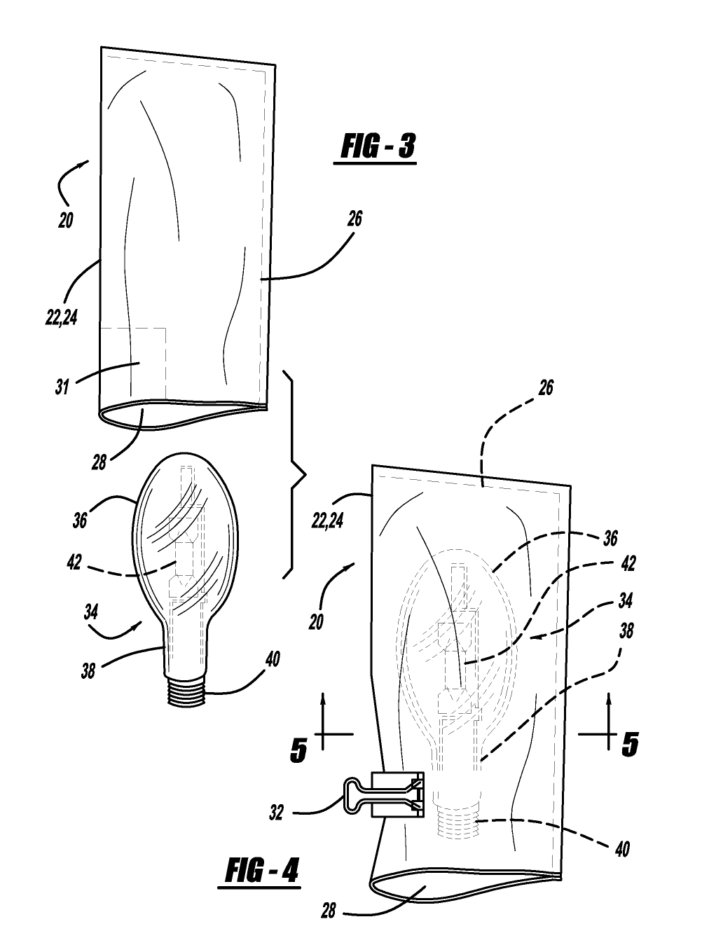

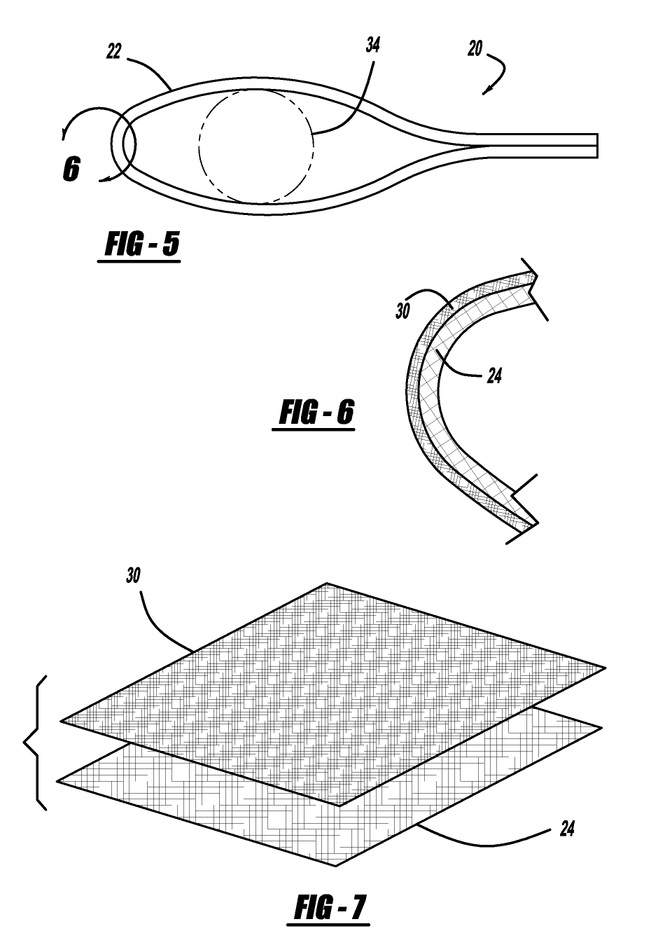

The preferred use of the lamp cover 20 described herein is use as a cover for a high-intensity discharge lamp 34. The lamp cover 20 can also be used as a cover for lamps which are not high-intensity discharge lamps 34. A metal halide high-intensity discharge lamp 34 is shown in FIG. 3. White light is produced within the arc tube 42 of the lamp 34. It is not unusual for arc tube 42 temperatures to reach 1100° C. The arc tube 42 is surrounded by a bulb 36. The bulb 36 converges into a neck 38 which is attached to a base 40. The base 40 provides for the physical and electrical connection of the lamp 34 to a lamp socket. The lamp socket secures the lamp 34 and provides electrical power for the lamp 34. Typical metal halide lamps 34 have peak bulb 36 temperatures which range between 400° C. and 650° C.

The lamp cover 20 is comprised of a jacket 22. The jacket 22 is bag shaped and has an open end 28. The jacket 22 is constructed from a flexible light transmitting material 24 capable of withstanding a temperature of at least 650° C. without degradation. The light transmitting material 24 must be translucent or transparent.

The preferred light transmitting material 24 is fiberglass. The preferred type of fiberglass is woven fiberglass cloth. Other types of fiberglass such as fiberglass woven roving, fiberglass roving, fiberglass mat and of fiberglass fabric may also be used. Polytetrafluoroethylene may also be used. Polytetrafluoroethylene is currently available under the trade name “TEFLON.” Woven fiberglass cloth has physical properties which are ideal for use as a lamp cover 20 jacket 22. Woven fiberglass cloth has high heat resistance. It has a softening point of 846° C. and a melting point of 1121° C. It is composed of inorganic noncombustible materials and is therefore fire resistant. It has good thermal conductivity which facilitates heat dissipation from a high-intensity discharge lamp 34 which it may cover. Fiberglass is also translucent. This permits light to be transmitted through it.

A lamp cover 20 and jacket 22 are shown in FIG. 3. The jacket 22 is comprised of woven fiberglass cloth. Lamp covers 34 with jackets 22 have been successfully tested using the following woven fiberglass cloth weights: 8.9 ounces per square yard, 3.2 ounces per square yard and 1.6 ounces per square yard. Successful testing is also anticipated for 6 ounces per square yard woven fiberglass cloth. This invention, however, is not limited by the stated fiberglass weights, but rather by the claim language contained herein.

A bag shaped jacket 22 with an open end 28, as shown in FIG. 3, can be fabricated from a rectangular piece of fiberglass. The fiberglass is folded such that it is bag shaped and has an open end 28. The bag shape is created by sewing a seam onto two open sides of the folded fiberglass, as shown in FIG. 3. The seam 26 should be made with a nonflammable material, such as wire or staples. The jacket 22 is shaped to cover the bulb 36 of a high-intensity discharge lamp 34 such that the jacket 22 may be manually installed upon and removed from the bulb 36. See FIG. 3 and FIG. 4. A section of the fiberglass jacket 22 proximal to the open end 28 may be used as a bunched section 31 to receive a clamp 32. After a lamp 34 is inserted into the lamp cover 20, a clamp 32 may be applied to the bunched section 31 of the jacket 22 to secure the lamp cover 20 to the lamp 34, as shown in FIG. 4. If the lamp 34 is oriented such that the lamp cover 20 has a tendency to be pulled off of the lamp 34 by gravity, the clamp 32 will ensure that the lamp cover 20 does not separate from the lamp 34.

The jacket 22 has a nonwhite color. The nonwhite color may be produced by treating the jacket material 24 with a nonflammable dye. By producing the nonwhite color with a dye incremental changes can be made to the jacket 22 color during production runs. The jacket color controls the light color emitted by a lamp 34 covered by a lamp cover. Thus, colors anywhere along the color spectrum can be produced.

In order to convert a high-intensity discharge lamp 34 to a bug lamp the jacket 22 is colored yellow. This will cause the covered lamp 34 to emit a yellow light. The attraction of insects to the lamp 34 is eliminated or significantly reduced when the lamp 34 emits yellow colored light, rather than white light.

The preferred way to color the jacket 22 yellow is to cover the surface of the jacket 22 with a layer of yellow high-temperature paint 30. The high-temperature paint 30 is a paint which is capable of withstanding temperatures exceeding 650° C. without degradation. When exposed to temperatures of 650° C. the high-temperature paint 30 must not combust, melt or physically change. Yellow engine header paint has these properties.

A satisfactory yellow header paint is currently available from PJH Brands Corp. under the trade name “VHT” and “FLAMEPROOF.” PJH Brands Corp. is affiliated with PJ1 Corp. The yellow header paint is marketed under product number SP-108. The manufacturer labels the color as “flat yellow amarillo matte.” The product is alternatively labeled as “FLAMEPROOF coating.” The header paint is comprised of a blend of ceramic and silicone chips. It is impervious to extreme temperatures of up to 1500° F. (816° C.). One version is impervious to extreme temperatures of up to 2000° F. (1093° C.). The maximum expected high-intensity discharge lamp 34 bulb 36 temperature is 650° C. (1202° F.).

A fiberglass jacket 22 may be colored yellow by spraying the surface with the yellow high-temperature paint 30. Several coats of paint 30 should be applied to the fiberglass 24. The coatings should be cured in accordance with the manufacturer's directions. The VHT FLAMEPROOF header paint should be cured at 250° F. for 30 minutes, then 30 minutes at 400° F., then 30 minutes at 650° F. This improves the finish and provides a durable surface for solvent resistance. The inherent heat of operation as encountered when a painted jacket 22 covers a high-intensity discharge lamp 34 may also accomplish curing.

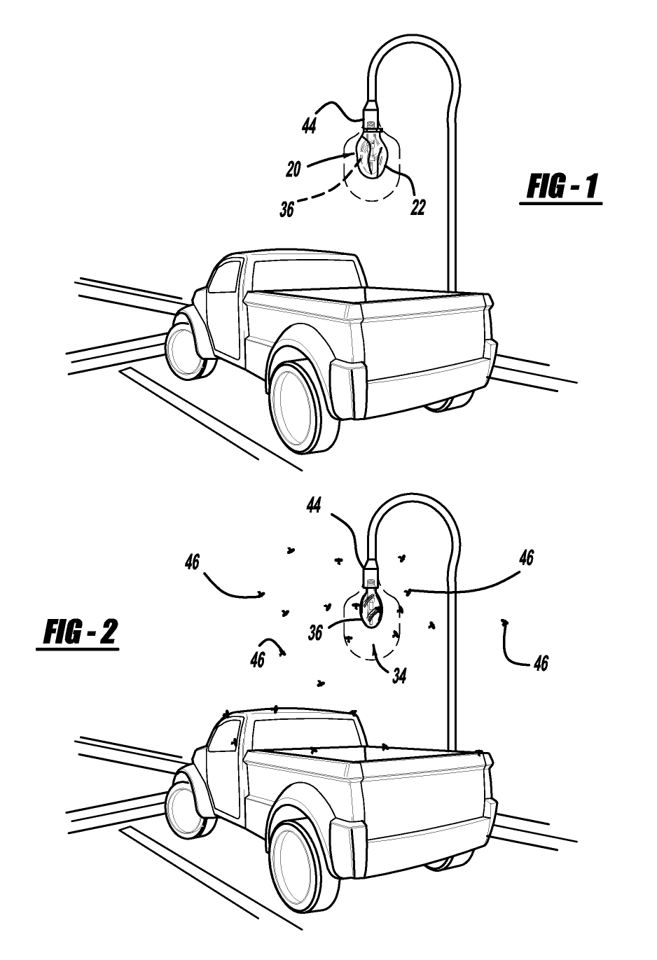

The lamp cover 20 described may be used to convert a high-intensity discharge lamp 34 to a bug lamp. A high-intensity discharge lamp 34, without a lamp cover 20, is shown in FIG. 2. The lamp 34 is installed within a light fixture 44. The white light emitted by the lamp 34 attracts insects 46. A lamp cover 20, such as that shown in FIG. 3, is selected. The jacket 22 of the lamp cover 20 is colored yellow. The lamp 34 is covered with the lamp cover 20, as shown in FIG. 4. This produces a yellow light emitting bug lamp, as shown in FIG. 1. Optionally, a clamp 32 may be applied to the bunched section 31 of the jacket 22, which is proximal to the open end 28 of the lamp cover 20, to secure the lamp cover 20 to the high-intensity discharge lamp 34.

The lamp cover 20 described herein facilitates converting a white high-intensity discharge lamp 34 to a yellow high-intensity discharge lamp. It also facilitates conversion of the lamp 34 to a different color for aesthetic purposes. The lamp cover 20 is easy to install and easy to remove. It has good heat dissipation properties. Neither the jacket material nor the agent used to color the material degrades or combusts at typical lamp 34 operating temperatures. The lamp cover 20 may be used to convert a metal halide lamp 34 to a yellow bug lamp.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A lamp cover comprising:
(a) a bag shaped jacket having an open end, said jacket being constructed from a flexible light transmitting material capable of withstanding a temperature of at least 650° C. without degradation, said jacket being shaped to cover the bulb of a lamp such that the jacket may be manually installed upon and removed from the bulb; and
(b) wherein said jacket has a non-white color.

2. The lamp cover of claim 1, wherein the jacket has been dyed to produce the color.

3. The lamp cover of claim 1, wherein the jacket is yellow.

4. The lamp cover of claim 1, wherein the flexible light transmitting material is fiberglass.

5. The lamp cover of claim 1, wherein the flexible light transmitting material is comprised of polytetrafluoroethylene.

6. The lamp cover of claim 1, wherein the jacket is dyed the color yellow and wherein the flexible light transmitting material is fiberglass.

7. The lamp cover of claim 1, further comprising a layer of high-temperature paint covering the surface of the jacket for converting the lamp to a colored light emitting lamp, said high-temperature paint being capable of withstanding temperatures exceeding 650° C. without degradation.

8. The lamp cover of claim 7, wherein the high-temperature paint is yellow.

9. The lamp cover of claim 7, wherein the flexible light transmitting material is fiberglass.

10. The lamp cover of claim 8, wherein the flexible light transmitting material is fiberglass.

11. The lamp cover of claim 3, wherein the flexible light transmitting material is fiberglass and wherein the lamp cover covers a high-intensity discharge lamp.

12. A high-intensity discharge lamp cover comprising:
(a) a fiberglass bag shaped jacket having an open end, said jacket being shaped to cover the bulb of a high-intensity discharge lamp such that the jacket may be manually installed upon and removed from the bulb; and
(b) a layer of yellow high-temperature paint covering the surface of the jacket for converting the lamp to a yellow light emitting bug lamp, said high-temperature paint being capable of withstanding temperatures exceeding 650° C. without degradation.

13. The high-intensity discharge lamp cover of claim 12, further comprising a clamp attached proximal to the open end of the jacket for securing the jacket to the bulb.

14. A method for converting a high-intensity discharge lamp to a bug lamp comprising:
(a) selecting a lamp cover comprising:
(i) a bag shaped jacket having an open end, said jacket being constructed from a flexible light transmitting material capable of withstanding a temperature of at least 650° C. without degradation, said jacket being shaped to cover the bulb of a lamp such that the jacket may be manually installed upon and removed from the bulb; and
(ii) wherein said jacket is colored yellow; and
(b) covering the lamp with the lamp cover, whereby a yellow light emitting bug lamp is produced.

15. The method for converting a high-intensity discharge lamp to a bug lamp of claim 14, wherein the jacket has been dyed to produce the yellow color.

16. The method for converting a high-intensity discharge lamp to a bug lamp of claim 14, wherein the flexible light transmitting material is fiberglass.

17. The method for converting a high-intensity discharge lamp to a bug lamp of claim 14, wherein the flexible light transmitting material is comprised of polytetrafluoroethylene.

18. The method for converting a high-intensity discharge lamp to a bug lamp of claim 15, wherein the flexible light transmitting material is fiberglass.

19. The method for converting a high-intensity discharge lamp to a bug lamp of claim 16, wherein a layer of high-temperature yellow paint covers the surface of the jacket to color the jacket yellow, said high-temperature paint being capable of withstanding temperatures exceeding 650° C. without degradation.

20. The method for converting a high-intensity discharge lamp to a bug lamp of claim 19, wherein the flexible light transmitting material is fiberglass.
